(19) United States
(12) Patent Application Publication
(10) Pub. No.: US 2002/0174058 A1
(43) Pub. Date: Nov. 21, 2002

(54) System for providing orders from a market analysis platform to the electronic communication network

(76) Inventor: George J. Baghdady, Trumbull, CT (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/147,240

(22) Filed: May 14, 2002

Related U.S. Application Data
(60) Provisional application No. 60/291,977, filed on May 18, 2001.

(51) Int. Cl. G06F 17/60

(52) U.S. Cl. 705/37; 705/36

(57) ABSTRACT

A system for connecting a (programmable) market analysis platform, such as the well known TradeStation market analysis platform, to the well-known (among daytraders) electronic communication network (ECN) in such a way that information corresponding to simulated buy and sell orders (signals) produced by the market analysis platform become actual orders that are automatically provided to a stock exchange.

### FIELD OF THE INVENTION

The present invention relates to computer systems used to automate aspects of trading on a stock exchange, and in particular to computer systems used to automatically buy and sell securities based on a predetermined, automated analysis of market data.

### BACKGROUND OF THE INVENTION

A well known analysis platform used by people who buy and sell stocks is TradeStation available from TradeStation Technologies (formerly Omega Research). TradeStation allows a user to write instructions to program TradeStation to perform analysis and issue alerts, signals, and simulated buy and sell orders (for stocks) based on stock information provided to TradeStation through a data feed. The buy and sell orders are simulated in that they are an output of the programmed instructions but are not provided in a form or via a mechanism that would cause the buy and sell orders to be actually executed on a stock exchange. Instead, the buy and sell orders are observed by a trader, who then uses some other software to execute the orders, communicating with a stock exchange via what is generally called (by daytraders) the electronic communication network (ECN) (implemented over the Internet) using some communication software suitable for the task. In the case of buy and sell orders placed by so-called daytraders, time is of the essence, and it is highly advantageous for buy and sell orders to be executed as soon as practicable.

The inventor is unaware of any system that allows taking the simulated buy and sell orders produced by TradeStation and automatically converting them to real buy and sell orders, i.e. getting the buy and sell orders to a gateway to the ECN so that they can be automatically communicated to a stock exchange and be executed.

### SUMMARY OF THE INVENTION

Accordingly, the present invention provides a system for linking a market analysis module to a gateway to the electronic communication network so as to provide to the gateway, for delivery to a stock exchange, buy and sell orders corresponding to simulated buy and sell orders issuing from the market analysis module, the system including: a coded trade strategy module, for providing buy and sell decisions to the market analysis module, the buy and sell decisions based on a data feed of stock prices being provided to the market analysis module, the buy and sell decisions prompting corresponding simulated buy and sell orders to be issued by the market analysis module and also corresponding order information; an order link module, responsive to the order information, for providing actual buy and sell orders in a form suitable for the gateway to the electronic communication network; wherein the order link module includes a dynamic link library routine for interfacing the order link module to the market analysis module.

In a further aspect of the invention, the order link module provides the actual buy and sell orders as parameters in a call to the gateway.

In another further aspect of the invention, the system also includes a system sentry module, responsive to information serving as a basis for periodic updates, and further responsive to information serving as a basis for alerts of power interruptions or other interruptions in trading activity. In some applications including a system sentry, the system sentry interfaces with an external monitor module, which in turn interfaces with the gateway and a log file of power interruptions to provide to the system sentry the information serving as a basis for periodic updates and at least some of the information serving as a basis for alerts of power interruptions or other interruptions in trading activity.

In still another further aspect of the invention, the market analysis module is a module that does not interface with comDLL routines, and in yet still even another further aspect of the invention, the order link module includes a win32DLL routine for interfacing with the market analysis module. Both comDLL routines and win32DLL routines are well known to those skilled in the art of developing software under the Windows operating systems available from Microsoft Corporation.

The invention provides a link (automated) between market analysis platforms such as TradeStation, available from TradeStation Technologies, Inc., and ECN gateway modules such as REDIPlus, available from Spear, Leeds & Kellogg, i.e. SLK. The link automatically translates the output of the market analysis platform into a form that is able to be input to the ECN gateway module.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of a system according to the invention.

### BEST MODE FOR CARRYING OUT THE INVENTION

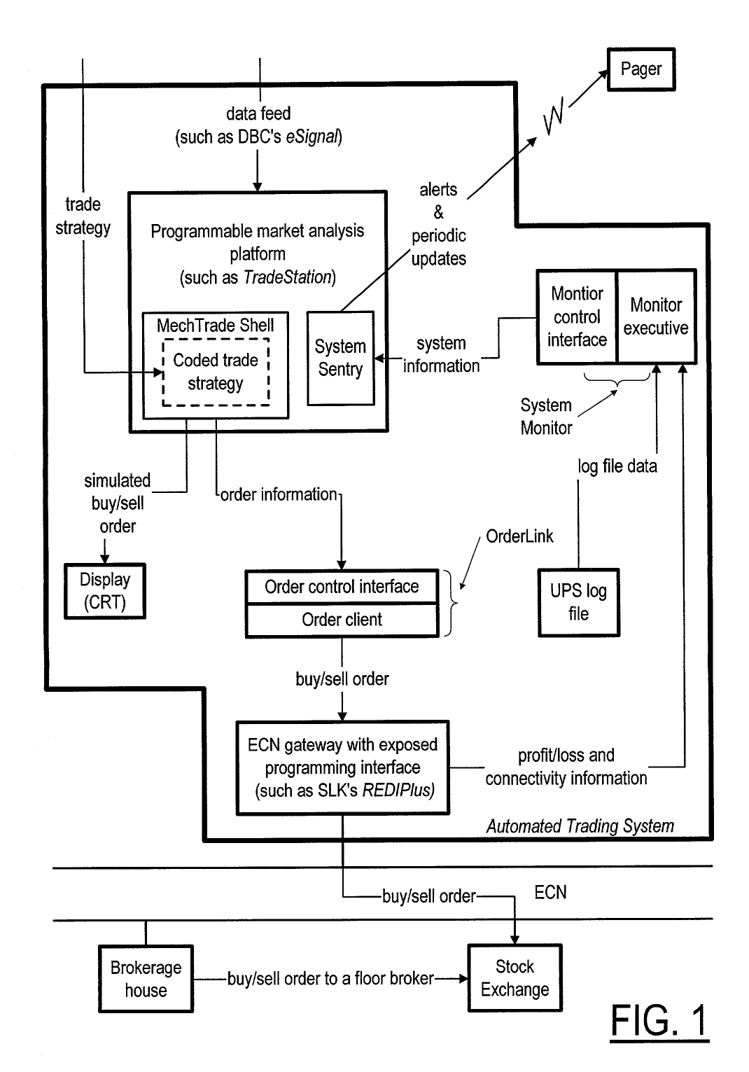

Referring now to FIG. 1, a system according to the invention includes a module called here OrderLink, which links to the so-called electronic communication network (ECN) gateway a shell program called here MechTrade executing according to a coded trade strategy (provided by a user) as part of a programmable market analysis platform; the coded trade strategy is programmed in the native language of the programmable market analysis platform. MechTrade automatically analyzes data and provides buy/sell orders (or signals), which, without the order link module, would be only simulated buy/sell orders, i.e. would not result in an actual transaction since the orders would not reach a stock exchange. According to the prior art, the simulated orders would be displayed to a trader who would then place an actual order (usually using some trade execution software that communicates with a stock exchange over the ECN), losing time between when the coded trade strategy module determined an order should be placed and the actual placement of the order. As indicated in FIG. 1, the programmable market analysis platform including MechTrade (with coded trade strategy) and a SystemSentry module, the Orderlink module, a system monitor module, and the ECN gateway make up an automated trading system, including as hardware one or more host computers and a video display terminal(s) (such as a CRT).

In the preferred embodiment, the programmable market analysis platform is TradeStation, available from TradeStation Technologies, Inc., and provides an editor which can be used to write programs/routines that generate (simulated) buy or sell orders (signals) for various securities based on analysis of information obtained via a data feed of stock prices and market information being fed continually to TradeStation, such as via Data Broadcasting Corporation's (DBC's) eSignal data feed.

MechTrade is a shell program (a program that executes other programs or code) in that it accepts and implements a trade strategy. In the preferred embodiment, MechTrade is written for and embedded in TradeStation (but the invention also comprehends analogous shell programs embedded in analogous programmable market analysis platforms). MechTrade executes according to the trade strategy instructions which are either hard-coded into MechTrade or entered as inputs at runtime. Its functions include performing analysis, providing buy/sell orders (signals), and managing trading activity and securities positions.

OrderLink includes two components, an order control interface and an order client in the sense of a client/server pair, the server in this case being the ECN gateway. The control interface facilitates communication between OrderLink and MechTrade, and in particular receives as parameters passed by MechTrade (via function calls from that program) the order information corresponding to the simulated buy and sell orders (signals) issued by MechTrade according to the loaded instructions (the coded trade strategy). TradeStation is somewhat unique in that it does not recognize comDLL routines, i.e. component object model dynamic link library routines as written for Windows operating systems. According to the invention, in the case that the market analysis platform is TradeStation and the operating system is a Windows operating system, the control interface of the OrderLink module is a win32DLL module, i.e. a regular 32-bit dynamic link library routine for Windows operating systems that can interface (at the operating system level) with TradeStation to obtain the order information corresponding to the simulated buy and sell orders (signals) issued by MechTrade. The win32DLL module is preferably implemented using C++. The order client module of OrderLink is preferably implemented using Visual Basic, and is essentially a comDLL routine.

In embodiments where the analysis platform is not TradeStation and is of a type whose editor does support comDLL routines, or where the order client is a win32DLL, the control interface of the OrderLink module can be omitted from the invention.

The control interface of the OrderLink module is linked together with the order client so as to make a single executable OrderLink module. The order client component takes the order information corresponding to the simulated buy and sell orders (signals) obtained through the control interface, prepares an order, and submits it (for execution) to an ECN gateway program by calling that program's interface. The ECN gateway then provides the buy and sell orders to a stock exchange over the electronic communication network, as indicated in FIG. 1.

In the preferred embodiment, the order client interfaces with the well-known REDIPlus program (available from Spear, Leeds & Kellogg, i.e. SLK). Alternatively, the order client interfaces directly with the ECN through the so-called FIX technology (financial information exchange protocol, developed by FIX Protocol Organization). In general, the invention works with any ECN gateway of a type having an exposed programming interface so as to be callable with parameter passing, or controllable through manipulating its properties or invoking its methods.

Still referring to FIG. 1, in the preferred embodiment the invention also includes a component called here SystemSentry (mentioned above), embedded in the (programmable) market analysis platform and serving to alert a user of the system, via a pager, in case there is an interruption in the operation of the MechTrade module (executing according to the coded trade strategy), either because of a power failure or because of some other glitch somewhere in the chain of systems that provides data to the market analysis platform or effects (makes happen) orders on the ECN. SystemSentry also provides periodic profit and loss updates to the user, and receives the information (system information) serving as the basis for alerts and periodic updates from a system monitor module, which is external to the market analysis platform and which in turn acquires the information for the periodic updates from the ECN gateway and acquires the information used to determine whether to issue an alert from both a UPS (uninterruptible power supply) log file (maintained by a UPS, not shown) and from the ECN gateway (the ECN gateway providing connectivity information when queried by the monitor module, as well as profit and loss updates, as mentioned above). In the preferred embodiment, the external monitor module (system monitor) interfaces with SystemSentry via a monitor control interface (similar in function to the control interface for OrderLink), which is preferably implemented in C++, and also includes a monitor executive module, preferably implemented using Visual Basic, which interfaces with the ECN gateway and with the UPS log file allowing SystemSentry to access information (system information) on ECN connectivity, profit and loss, and power status that is otherwise unavailable from the market analysis platform. SystemSentry issues an alert in case of either an interruption in power as indicated by the UPS log file, a break in operation of the ECN gateway program as indicated by the ECN connectivity data, or because periodic data feed updates are not being received (to the market analysis platform) with the usual frequency.

It should be noted that in the preferred embodiment, SystemSentry receives all information for periodic updates (i.e. including profit and loss information) from the ECN gateway through the system monitor, and receives some connectivity information in the same way from the ECN gateway, but also receives some connectivity information (in respect specifically to the data feed) directly from TradeStation. In alternative embodiment, SystemSentry gets the profit and loss information from the market analysis platform itself, rather than from ECN gateway via the system monitor.

### SCOPE OF THE INVENTION

It is to be understood that the above-described arrangements are only illustrative of the application of the principles of the present invention. Numerous modifications and alternative arrangements may be devised by those skilled in the art without departing from the spirit and scope of the present invention, and the appended claims are intended to cover such modifications and arrangements.

What is claimed is:

1. A system for linking a market analysis module to a gateway to the electronic communication network so as to provide to the gateway, for delivery to a stock exchange, buy and sell orders corresponding to simulated buy and sell orders issuing from the market analysis module, the system comprising:
a) a coded trade strategy module, for providing buy and sell decisions to the market analysis module, the buy and sell decisions based on a data feed of stock prices being provided to the market analysis module, the buy and sell decisions prompting corresponding simulated buy and sell orders to be issued by the market analysis module and also corresponding order information;
b) an order link module, responsive to the order information, for providing actual buy and sell orders in a form suitable for the gateway to the electronic communication network;
wherein the order link module includes a dynamic link library routine for interfacing the order link module to the market analysis module.

2. A system as in claim 1, wherein the order link module provides the actual buy and sell orders as parameters in a call to the gateway.

3. A system as in claim 1, further comprising a system sentry module, responsive to information serving as a basis for periodic updates, and further responsive to information serving as a basis for alerts of power interruptions or other interruptions in trading activity.

4. A system as in claim 3, wherein the system sentry interfaces with an external monitor module, which in turn interfaces with the gateway and a log file of power interruptions to provide to the system sentry the information serving as a basis for periodic updates and at least some of the information serving as a basis for alerts of power interruptions or other interruptions in trading activity.

5. A system as in claim 1, wherein the market analysis module is a module that does not interface with comDLL routines.

6. A system as in claim 1, wherein the order link module includes a win32DLL routine for interfacing with the market analysis module.
